(19) United States
(12) Patent Application Publication
(10) Pub. No.: US 2013/0268277 A1
(43) Pub. Date: Oct. 10, 2013

(54) WIRELESS TRANSACTION COMMUNICATION APPARATUS AND METHOD

(71) Applicant: Lucas A. DUPLAN, Mountain View, CA (US)

(72) Inventor: Lucas A. DUPLAN, Mountain View, CA (US)

(73) Assignee: Clinkle Corporation, Mountain View, CA (US)

(21) Appl. No.: 13/439,343

(22) Filed: Apr. 4, 2012

(51) Int. Cl. H04B 7/00; G10L 19/00

(52) U.S. Cl. 704/500; 381/77; 704/E19.001

(57) ABSTRACT

The invention can be a simple method for data transfer from one electronic device to another. In this embodiment, a sender can upload data to a server using an out-of-band connection while broadcasting an identification signal over one or several mediums, such as acoustic and/or radio (Ultrasound, Bluetooth, infrared, etc. . . . ). In the case that a connection to the server can be established, the receiver will detect the identification signal, decode it, and request the information from the server. The receiver can then send an authorization for a transaction through the server via an out-of-band connection or directly to the sender via one of the primary communication mediums, at which point the transaction is complete.

### FIELD OF THE INVENTION

This invention relates generally to the field of wireless communications and transactions.

### BACKGROUND

Today, mobile devices span a wide range of hardware capabilities, and existing methods for achieving real-time communication between mobile devices have generally relied on specialized hardware. This hardware is not available on all mobile devices, and it may be incompatible with certain mobile devices.

As an example, near field communication (NFC) is a technology that allows for contact-range point-to-point transmission of data. NFC, however, requires hardware that is not found in traditional mobile devices. In addition, NFC is generally not usable outside of a range of around four centimeters. There can, therefore, be drawbacks with NFC.

Other existing technologies also have drawbacks, such as not allowing for real-time communication, requiring specific hardware, or requiring close contact between devices. A need, therefore, exists for a more flexible real-time communication apparatus and method.

### SUMMARY OF INVENTION

According to one embodiment, a computer readable medium contains instructions that, when executed, perform the steps of (a) receiving a signal within a predetermined frequency band with a microphone of a second device, wherein the signal contains information to identify a first device containing a speaker to the second device, and (b) transmitting information for a transaction from the second device to a server, wherein the transaction relates to the first device and the second device, and wherein the information for the transaction is based at least in part on data from the first device. The first and second devices can both be wireless mobile devices, such as smart phones or tablets. In addition, the signal may be transmitted within an ultrasonic frequency band. In use, this embodiment of the invention allows the devices to be used for, as an example, a financial transaction, such as a purchase at a point of sale. The first device can be, for example, a tablet at the point of sale, and the second device can be, for example, the purchaser's wireless mobile device.

Another embodiment of the invention is a computer readable medium containing instructions that, when executed, perform the steps of (a) transmitting a signal within a predetermined frequency band from a speaker of a first device, wherein the signal contains information to identify the first device to a second device containing a microphone, and (b) receiving at the first device authorization for a transaction from a server, wherein the transaction relates to the first device and the second device, and wherein the authorization is based at least in part on data from the second device. The first and second devices can, once again, both be wireless mobile devices, such as smart phones or tablets. In addition, the signal may be transmitted within an ultrasonic frequency band. In use, this embodiment of the invention allows the devices to be used for, as an example, a financial transaction, such as a purchase at a point of sale. The first device can be, for example, a tablet at the point of sale, and the second device can be, for example, the purchaser's wireless mobile device.

Yet other embodiments of the invention can include methods that include the steps of either of the embodiments set forth above. Still other embodiments can include methods or computer readable mediums that include steps to provide a simple method for payments from one wireless device to another, where one device is a “sender” and the other a “receiver.” In such an embodiment, the sender may upload payment data or transaction information to a server using an out-of-band connection while broadcasting an identification signal through a built-in speaker following an acoustic protocol over a predetermined frequency band, such as an ultrasonic band. In tandem, the receiver can detect the identification signal via its microphone, decode this signal, and request the transaction information from the server that relates to the sender. Because the receiver has decoded the signal from the sender, the receiver can send a signal to the server to indicate that the receiver is within range of the specific sender for which the receiver has decoded the identification signal, and this allows the receiver to request the transaction information from the server that relates to the sender and the receiver. After processing the transaction information, the receiver can send an acknowledgement or authorization for the transaction through the server to the sender, at which point the transaction is complete.

### BRIEF DESCRIPTION OF THE DRAWINGS

The invention is illustrated in the figures of the accompanying drawings which are meant to be exemplary and not limiting, in which like references are intended to refer to like or corresponding part, and in which:

FIG. 1 is a flow diagram of a method that can be used according to a preferred embodiment of the disclosed subject matter;

FIG. 2 is a flow diagram of a second method that can be used according to an embodiment of the disclosed subject matter;

FIG. 3 is a diagram of a device that can be used according to the embodiments of FIG. 1 or 2;

FIG. 4 is a block diagram showing greater detail of the device of FIG. 3;

FIG. 5 is a flow diagram that sets forth a more detailed set of steps that can be used to carry out the invention according to one embodiment;

FIG. 6 is a block diagram that shows the setup phase of FIG. 5;

FIG. 7 is a block diagram that shows the transmit phase of FIG. 5;

FIG. 8 is a block diagram that shows the receive phase of FIG. 5; and

FIG. 9 is a block diagram that shows the acknowledgement phase of FIG. 5.

### DETAILED DESCRIPTION

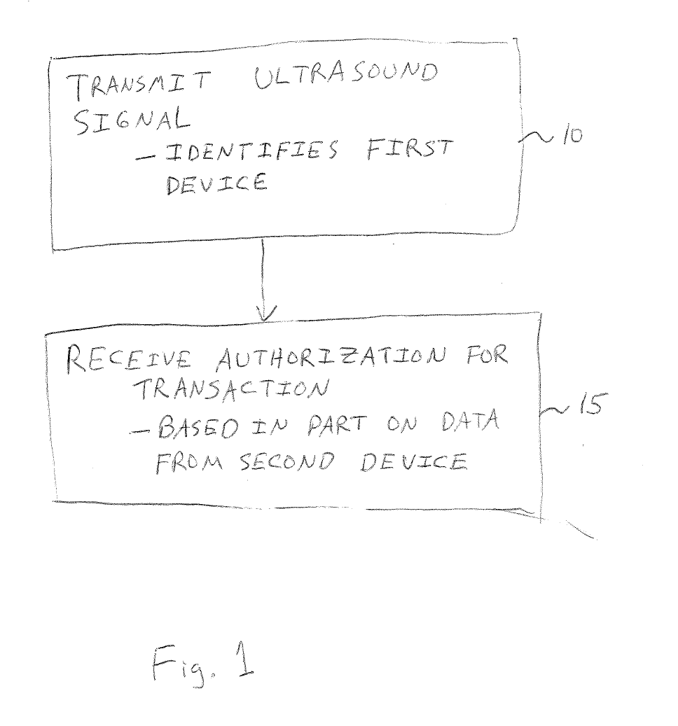

To address the need set forth above, according to one aspect, the invention includes transmitting a signal from a speaker of a first device, and receiving information for a transaction from a server. FIG. 1 is a flow chart for such a method for steps performed within the first device. First, in step 10, the first device uses its speaker to transmit a signal within a predetermined frequency band that identifies the first device to a second device. The signal can be transmitted, for example, within an ultrasonic frequency band. Second, in step 15, authorization for the transaction can be received from a server. The transaction information relates in part to data from the second device. The first and second devices can each be wireless mobile devices, such as smart phones or tablets. In the method set forth in FIG. 1, the second device can use the signal transmitted by the first device to identify the first device. At the same time, the first device can transmit transaction information to the server on an out-of-band connection. The second device can receive this transaction information from the server and then authorize the transaction. Ultimately, the first device can receive the authorization for the transaction from the server (i.e., step 15).

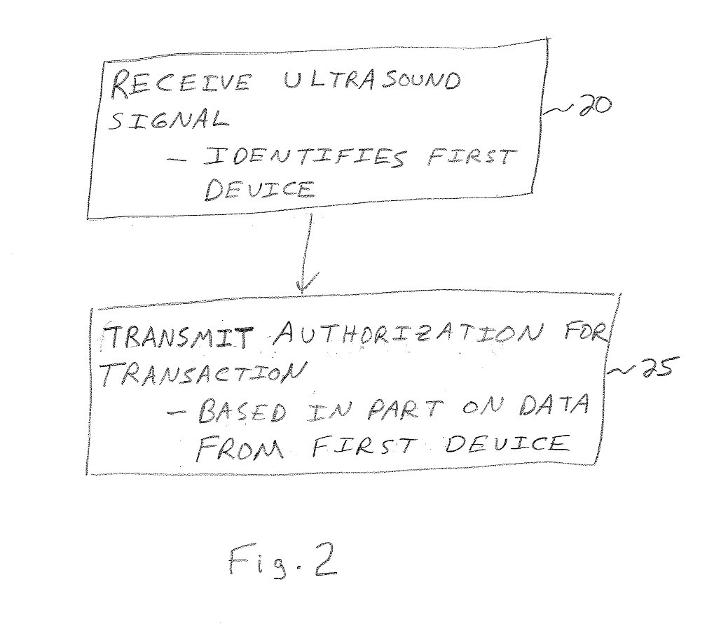

According to another aspect of the invention, the invention includes receiving a signal within a predetermined frequency band from a first device with a microphone of a second device, and transmitting authorization for a transaction from a server. FIG. 2 is a flow chart for such a method and involves steps performed within the second device. First, in step 20, the second device uses its microphone to receive a signal that identifies the first device to the second device. The signal can be transmitted, for example, within an ultrasonic frequency band. Second, in step 25, information for a transaction can be received from a server by the second device. The transaction information relates in part to data from the first device. The first and second devices can each be wireless mobile devices, such as smart phones or tablets. In the method set forth in FIG. 2, the second device can use the signal transmitted by the first device to identify the first device. At the same time, the first device can transmit transaction information to the server on an out-of-band connection. The second device can receive this transaction information from the server and then authorize the transaction (step 25). Ultimately, the first device can receive the authorization for the transaction from the server.

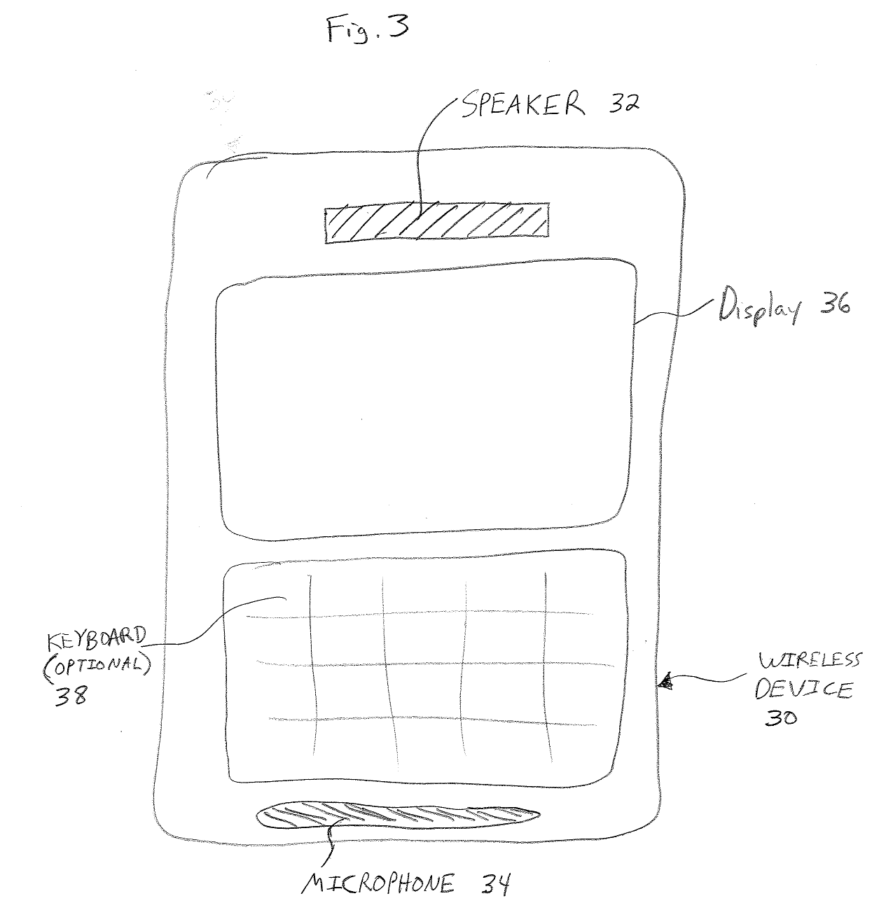

FIG. 3 shows a device 30 that can be used, in part, to carry out the invention described above. The device 30 can be used for both the first device and the second device described above. In one embodiment, the first device is a tablet computer, which can be a wireless device, and the second device is a wireless mobile device such as a smart phone. In other embodiments, both the first and second devices can be tablet computers or both can be smart phones. The smart phone can be any type of smart phone known in the art, including, for example, an iPhone or an Android smart phone. In addition, the tablet can be any type of tablet known in the art, including, for example, an iPad or an Android tablet.

Referring again to FIG. 3, the device 30 can include, for example, a speaker 32, a microphone 34, a display 36, and a keyboard 38. In some embodiments, a touch screen device may be used such that the device 30 does not include a traditional keyboard 38. At least the first device described above includes a speaker 32, which may be the same speaker used by the device 30 for other functions, such as for a telephone speaker or a speaker for music or other audio features. In addition, at least the second device described above includes a microphone 34, which may be the same microphone used by the device 30 for other functions, such as for telephone calls. Of course, each of the first and second devices can include a speaker 32 and a microphone 34. The display 36 and keyboard 38 can be the same structures used for other functions. Accordingly, the invention does not require any special-purpose hardware, but can instead be used with the hardware that is available on most smart phones or tablets.

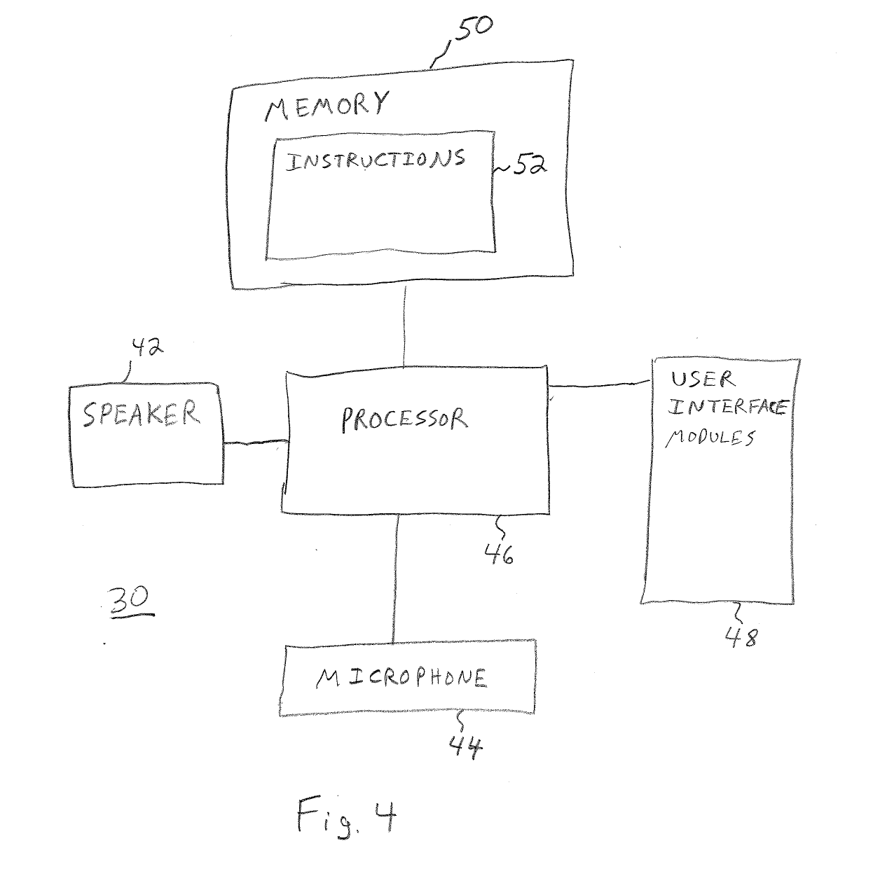

FIG. 4 is a block diagram of the components of the device 30 of FIG. 3. FIG. 4 shows that the device 30 includes a speaker 42 and a microphone 44, as also shown in FIG. 3. In addition, the device 30 can include a processor 46, user interface modules 48, and memory 50. The processor 46 can be any processor known in the art for use in computing devices. In one embodiment, where device 30 is a mobile device, the processor 46 can be a low power mobile processor, such as, but not limited to, an ARM processor. The processor 46 can interact with the user interface modules 48 to provide an interface to the user. For example, the user interface modules can include software for interacting with a touch screen or a display, as well as software for interacting with a keyboard.

The memory 50 can be any standard memory device, such as NAND or NOR flash memory or any other type of memory device known in the art. The memory 50 stores instructions 52. These instructions 52 can be the code that performs the functions described above for the first and/or second devices. The instructions 52 can include the logic for both the first and second devices. Alternatively, the code can store the instructions for either the first device or the second device. In other words, the embodiment of FIG. 4 can be used for the first device, the second device, or both the first and second devices. During operation, the instructions can be executed by the processor 46 in order to perform the functions described herein.

In operation, the code for performing the functions of the first device and/or the second device can be loaded onto the device 30. The code to perform these functions can be stored, either before or after being loaded on device 30, on a computer readable medium. When loaded onto a device 30 and executed, the code can perform the logic described above and in the sections below.

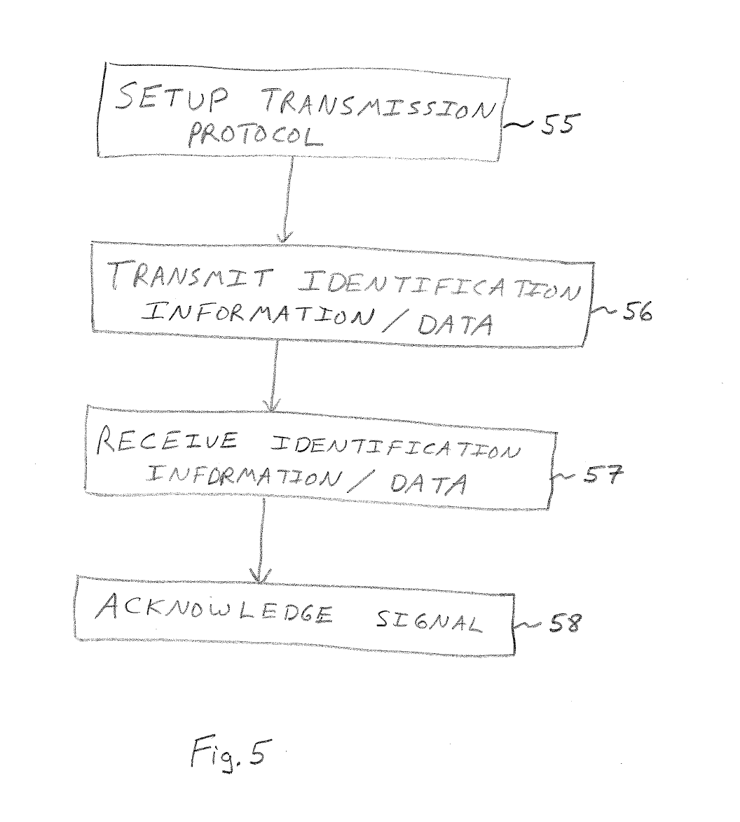

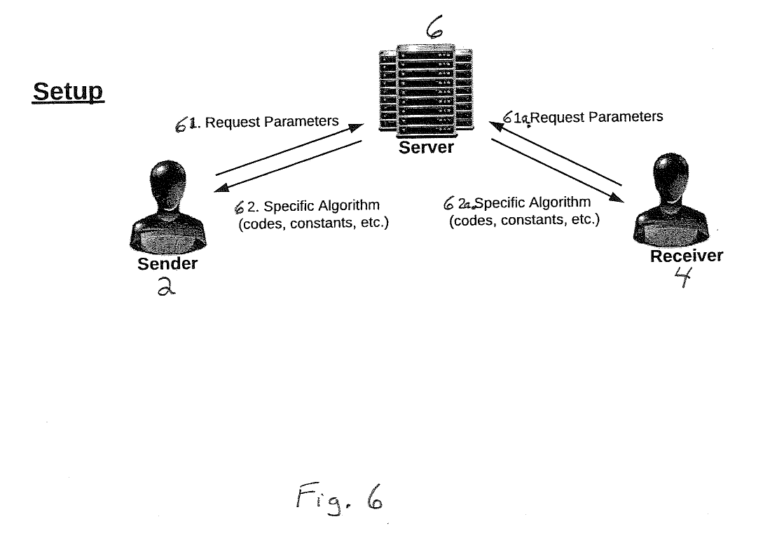

FIG. 5 is a flow chart that sets forth a more detailed set of steps that can be used to carry out the invention. FIGS. 6-9 describe each of the steps in FIG. 5 in greater detail. In addition, FIGS. 6-9 show the use of three entities for performing these steps. First, a first device that can be used according to the invention can be a sender 2, as shown in FIGS. 6-9. This sender 2 can be a device 30 of the type described above and can include at least a speaker. Second, the second device that can be used according to the invention can be a receiver 4, as shown in FIGS. 6-9. This receiver 4 can be a device 30 of the type described above and can include at least a microphone. Third, the system according to the invention can use a server 6. The server 6 can be any computerized device that can be used to facilitate a transaction between the sender 2 and the receiver 4, such as a computer run by a financial institution, credit card company, or other business or private entity. The server 6 executes instructions to facilitate the transmission of transaction information between the sender and the receiver. The server 6 requires no set physical location due to the sender's and receiver's connection to the server through a network system and may be operated by a third party. The server 6 can communicate with at least the first device (or sender 2) wirelessly or over a landline connection (or a combination of wireless and landline connections), and the server 6 can communicate with the second device at least wirelessly.

According to one embodiment, the invention is a method of data transmission between two mobile devices (the sender 2, which is equipped with a speaker, and a receiver 4, which is equipped with a microphone) that utilizes acoustic data transmission for device recognition and an out-of-band server 6 for primary data transfer. The out-of-band connection with the server 6 can be over a cellular wireless telephone connection or a WiFi connection. This data transmission protocol according to the invention can include a setup phase, a transmit phase, a receive phase, and an acknowledge phase. More specifically, referring again to FIG. 5, the data transmission protocol according to one embodiment of the invention can include a setup phase 55 for a transmission protocol, a transmit phase 56 where the first device (sender 2) transmits identification information to the second device (receiver 4), a reception phase 57 where the second device (receiver 4) receives the identification information, and an acknowledgement phase 58. Each of these phases is described in greater detail below.

Referring to FIG. 6, during the setup phase 55 (of FIG. 5), the sender 2 and receiver 4 pull a transmission protocol from the server 6, as described in greater detail in the following sections. For example, one implementation includes one default transmission protocol, but it is not limited to a particular transmission protocol or a particular implementation of that protocol. During this phase, the sender 2 and receiver 4 agree to a transmission protocol that specifies transmit and receive algorithms and codes to be used. Accordingly, in FIG. 6, the sender 2 and the receiver 4 both request parameters for the transmission/reception protocol in steps 61, 61a. In steps 62, 62a, the server 6 delivers a specific transmission/reception protocol to the sender 2 and the receiver 4. The specific transmission/reception protocol can include the instructions to be used for transmission, constants specifying a unique data encoding method, and other information for transmission and reception.

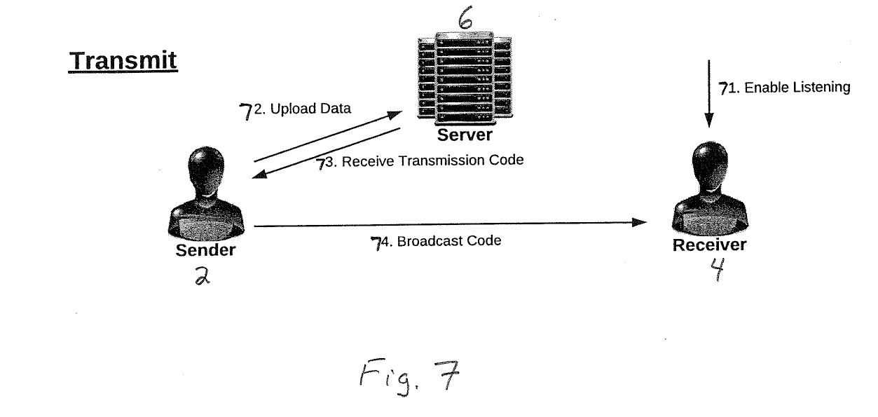

Referring to FIG. 7, during the transmit phase 56 (of FIG. 5), information can be exchanged. At the beginning of the transmit phase, the sender 2 sets the appropriate volume setting on its speaker so that it can transmit its identification to the receiver 4. The receiver, in step 71, enables listening so that it can detect the signal transmitted by the sender 2. As set forth above, the receiver 4 can use its microphone to receive the signal from the sender 2. In step 72, the sender 2 uploads the data to the server 6 so that the data can ultimately be delivered to the receiver 4. Next, in step 73, the sender 2 can receive a particular transmission code from the server 6 to be used for the exchange of information. The sender 2 then broadcasts an identification signal as specified by the transmission protocol in step 74. As previously noted in step 71, the receiver 4 listens through its microphone for valid identification signals from the sender 2. Accordingly, the receiver 4 can receive the signal broadcast by the sender 2.

As noted above, the sender 2 can use its speaker to broadcast the identification signals. In addition, the identification signals can be broadcast as within an ultrasonic frequency band. In addition, the receiver 4 can use its microphone to receive the signal from the sender 2. Accordingly, no special hardware is needed to carry out the invention aside from that which is present in a typical smart phone or tablet computer.

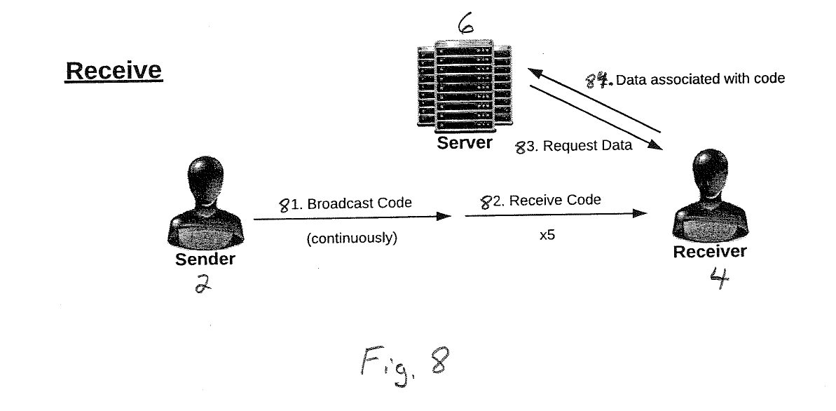

Referring to FIG. 8, during the receive phase 57 (of FIG. 5), the receiver 4 can receive the signal from the sender 2. If the receiver 4 is in-range of the identification signal, the receiver 2 can decode the signal and then recover the appropriate data from the server 6. Accordingly, when the sender 2 broadcasts its code in step 81 of FIG. 8, the receiver 4 can receive the code in step 82 and decode it accordingly. Next, in step 83, after receiving the code from the sender 2, the receiver 4 can request data from the server 6. In step 84, the server 6 can deliver the data associated with the code to the receiver 4.

According to the steps set forth above, the sender 2 does not typically transmit sensitive data directly to the receiver 4. Instead, the short-range wireless communication is used between the sender 2 and receiver 4 only to properly identify the sender 2 to the receiver 4. The exchange of any sensitive information, such as financial transaction information, can be securely transmitted from the sender 2 to the server 6 and then from the server 6 to the receiver 4.

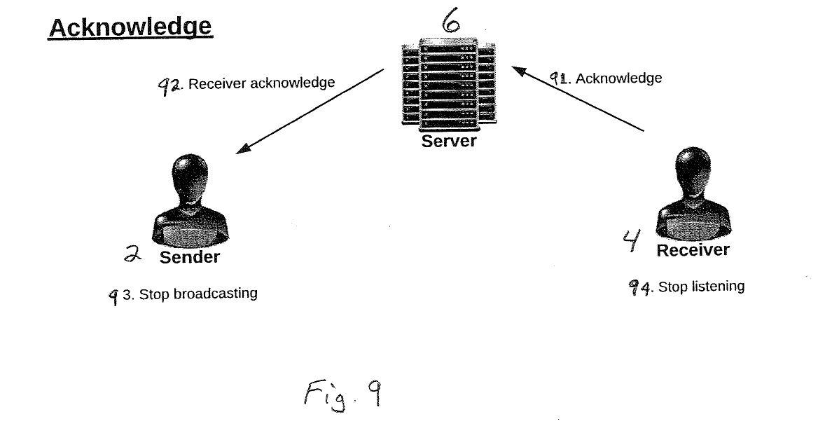

Referring to FIG. 9, during the acknowledgement phase 58 (of FIG. 5), the receiver 4 can acknowledge that it has received the relevant data. Typically, the receiver 4 uses an out-of-band channel for the acknowledgement phase (the channel is different from the channel on which the sender 2 broadcasts its identification information). Accordingly, after primary data reception is complete, the receiver 4 initiates the acknowledgement phase, during which the receiver 4 sends an acknowledgement signal to the server 6 during step 91. The server 6 then sends the receiver acknowledgement to the sender 2 in step 92. In step 93, the sender 2 may stop or continue broadcasting its identification signal, and in step 94, the receiver 4 may stop or continue listening for the identification signal. In some embodiments of the invention, the sender 2 will continue to broadcast its code until receiving the acknowledgement signal from the server 2, at which point all communication ceases. In other embodiments, the sender 2 will continue to broadcast its code even after receiving the acknowledgement signal from the server 2.

Referring again to the setup phase shown in FIG. 6, the sender 2 and receiver 4 synchronize on the allowable codes to be used for the communication. In addition, the sender 2 and receiver 4 agree upon the corresponding echo delays and allowable codes by point-to-point communication with the server 6. In one embodiment, the default transmission protocol transmits an integer code using echo delay encoding of ultrasonic waves in the 19 kHz-21 kHz band. At the time of transmission, the sender 2 generates a random noise profile stream and emits this profile through a band-pass filter permitting 19 kHz-21 kHz. After a time delay d=c+1 milliseconds have elapsed, where c is a store specific encoding delay, the same noise profile is added to the output. Simultaneously, the receiver 4 buffers up to 500 milliseconds of microphone input sampled at 44.1 kHz and computes the peaks of the convolution of the signal with itself. The time delay d′ of the first peak after 0 ms is regarded as the received code. To expand beyond the simple 1-to-1 mapping of delay to sender identification a tree-based algorithm may be implemented where each one of x unique signals may specify a direction through a tree of depth y to account for (x)̂y possible unique sender identifiers. To account for false positives and random similarities in the noise profile, in one embodiment, the receiver 4 must receive the same code in a set number of consecutive buffer intervals before accepting the transmitted code as reliable.

The transmission protocol can also require the sender 2 and receiver 4 to have out-of-band access to an external server 6, as shown in FIGS. 6-9. In other embodiments, the receiver 4 need not have communication with the server 6 out-of-band during the time of the transaction with the server 6. For example, if the receiver 4 has already received the transmission protocol to be used for communication and the sender 2 also has the same protocol information, it may be possible for the receiver 4 to be used according to the invention even if it does not have communication with the server 6 at the point of the transaction (such as at the point of sale). For instance, if the receiver 4 is a wireless smart phone, but it is in a location where there is not cellular service or WiFi service (both of which can typically be used for communication with the server 6), it may still be possible to perform the transaction. In one such embodiment, the sender 2 will broadcast its identification code and the receiver 4 will listen for the code, as described above. In this embodiment, instead of having the receiver 4 download data for the transaction from the server 6, the receiver 4 may send and receive transaction information directly from the sender 2 using the agreed upon protocol over the medium utilized for device recognition. The sender 2 can thereafter relay this identification and transaction information to the server 6, and this can provide authorization for the transaction. For instance, the receiver 4 may be able to provide authorization for a transaction to the server 6 through the sender 2.

According to one aspect of the invention, an object of the invention is to provide a simple method for payments from one wireless device to another. In such an embodiment, as set forth above, the sender will upload payment data to a server using an out-of-band connection while broadcasting an identification signal through a built-in speaker following an acoustic protocol over the 19 kHz-21 kHz band. As a specific example for a point-of-sale embodiment, the sending device may be used by a merchant. The sender can send to the server the amount of money that the user of the receiving device must pay for the transaction. For instance, if a good at the point of sale costs $7.55, the sender can send this amount to the server. In tandem, the receiver will detect the identification signal via its microphone, decode this signal, and request the transaction information from the server. After processing the transaction information, the receiver will send an acknowledgement signal through the server to the sender, at which point the transaction is complete. For instance, the receiver listens for the identification signal from the sender and then decodes this signal. After decoding it, the receiver sends a signal to the server to indicate that the receiver is within range of the specific sender for which the receiver has decoded the identification signal. The server may then route the sale cost information (the transaction information) to the receiver. In the specific example set forth above, for instance, the receiver will receive information indicating that the purchase will cost $7.55. The user of the receiver can acknowledge that it is OK to pay this amount to the merchant, and this will result in the receiver sending an acknowledgement signal through the server to the sender. Upon receiving this acknowledgement signal, the sender knows that the receiver has approved of the transaction and the transaction is complete. This embodiment can use echo delay encoding, using the delay between repetitive signals to encode identification information. Other protocols could also be used according to this embodiment. Such a method can result in a simple method for the user of the receiver to pay for goods at the point of sale without using cash or a credit card.

In another embodiment for payment between two wireless devices, the invention can involve the sender uploading payment data to a server using an out-of-band connection while broadcasting an identification signal through a built in speaker following an acoustic protocol over the 19 kHz-21 kHz band. If no connection to the server can be established, communication may occur solely over the acoustic medium. In the case that connection to a server can be established, the receiver will detect the identification signal via microphone, decode it, and request the payment information from the server. After processing the payment information, the receiver will send an acknowledgement signal through the server via an out-of-band connection or directly to the sender via acoustics, at which point the transaction is complete. The invention can include several encoding protocols for acoustic data transfer, such as utilization of a tree structure for more expansive mapping, although the primary is echo delay encoding using the delay between repetitive signals to encode identification information in a 1-1 mapping.

In yet another embodiment, the object of the invention is to provide a simple method for data transfer from one electronic device to another. In this embodiment, a sender will upload data to a server using an out-of-band connection while broadcasting an identification signal over one of several mediums, including acoustic and radio (Ultrasound, Bluetooth, infrared, etc. . . . ). In addition, if no connection to the server can be established, communication may occur directly over one of the aforementioned mediums. In the case that connection to a server can be established, the receiver will detect the identification signal, decode it, and request the information from the server. After receipt of information, the receiver will send an acknowledgement signal through the server via an out-of-band connection or directly to the sender via one of the primary communication mediums, at which point the transaction is complete. The invention includes several encoding protocols for data transfer, with the default being echo delay encoding using the delay between repetitive signals to encode identification information in a 1-1 mapping or a tree structure providing for more expansive mapping. The invention can utilize other denser protocols when utilizing the acoustic or radio mediums.

According to the embodiments set forth above, the invention can enable phone-to-phone and phone-to-point of sale payments. Accordingly, the invention can be used for the transmission of financial information, such as for payment. In other embodiments, the invention can be used for other types of communications between devices. In addition, the communication medium can be acoustic. It can be, for example, within the ultrasound range, such as around 19-21 kHz. In other embodiments, the communication medium can be Bluetooth, NFC, acoustic, infrared, or any other medium.

As set forth above, the wireless mobile devices can be used to carry out the invention. The devices can be simply endpoints for broader coverage. In addition, the invention can utilize an out-of-band connection to the server for primary data transfer.

According to the embodiments described above, point-to-point communication between two devices can be established that does not require direct device-to-device contact. Instead, using the speaker of the sender and the microphone of the receiver, the embodiments can enable communication between the two devices over a greater distance, such as, for example, 5 meters. In addition, the embodiments described above do not require special hardware that is not typically present in a smart phone. For example, most smart phones are able to transmit and receive ultrasound signals. Further, the invention can enable real-time communication between two devices without requiring a lengthy binding process, which can be required for communication according to certain protocols.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A computer readable medium containing instructions that, when executed, perform the following steps:
(a) receiving a signal within a predetermined frequency band with a microphone of a second device, wherein the signal contains information to identify a first device containing a speaker to the second device; and
(b) transmitting information for a transaction from the second device to a server, wherein the transaction relates to the first device and the second device, and wherein the information for the transaction is based at least in part on data from the first device.

2. The computer readable medium of claim 1, wherein the information for the transaction is authorization for the transaction.

3. The computer readable medium of claim 1, wherein the signal is within an ultrasonic band.

4. The computer readable medium of claim 1, wherein the instructions, when executed, cause the second device to decode the signal, wherein the signal is an echo delay encoded signal.

5. The computer readable medium of claim 1, wherein the instructions, when executed, cause the second device to request and receive information from the server relating in part to the first device prior to transmitting information for a transaction.

6. The computer readable medium of claim 5, wherein the instructions, when executed, cause the transmitting step to be performed on an out-of-band connection.

7. The computer readable medium of claim 1, wherein the second device is a wireless mobile device.

8. The computer readable medium of claim 1, wherein the instructions, when executed, cause transmitting information for the transaction to include sending, from the second device to the first device for routing to the server, the information for the transaction authorization.

9. A computer readable medium containing instructions that, when executed, perform the following steps:
(a) receiving a signal within a predetermined frequency band with a microphone of a second device, wherein the signal contains information to identify a first device containing a speaker to the second device;
(b) receiving information for a transaction from a server on an out-of-band connection, wherein the transaction relates to the first device and the second device, and wherein the information for the transaction is based at least in part on data from the first device; and
(c) transmitting authorization for the transaction to the server on the out-of-band connection.

10. A method comprising:
(a) receiving a signal within a predetermined frequency band with a microphone of a second device, wherein the signal contains information to identify a first device containing a speaker to the second device; and
(b) transmitting information for a transaction from the second device to a server, wherein the transaction relates to the first device and the second device, and wherein the information for the transaction is based at least in part on data from the first device.

11. A computer readable medium containing instructions that, when executed, perform the following steps:
(a) transmitting a signal within a predetermined frequency band from a speaker of a first device, wherein the signal contains information to identify the first device to a second device containing a microphone; and
(b) receiving at the first device authorization for a transaction from a server, wherein the transaction relates to the first device and the second device, and wherein the authorization is based at least in part on data from the second device.

12. The computer readable medium of claim 11, wherein the instructions, when executed, cause the signal to be transmitted within an ultrasonic band.

13. The computer readable medium of claim 11, wherein the first device is a wireless mobile device.

14. The computer readable medium of claim 13, wherein the second device is a wireless mobile device.

15. The computer readable medium of claim 11, wherein the instructions, when executed, cause the first device to upload transaction information to the server using an out-of-band connection.

16. The computer readable medium of claim 15, wherein the out-of-band connection is a cellular wireless telephone connection.

17. The computer readable medium of claim 11, wherein the instructions, when executed, cause transmitting a signal within a predetermined frequency band from a speaker of a first device using echo delay encoding to encode the signal.

18. The computer readable medium of claim 17, wherein the instructions, when executed, include using echo delay encoding using the delay between repetitive signals to encode the information to identify.

19. A computer readable medium containing instructions that, when executed, perform the following steps:
(a) transmitting a signal within a predetermined frequency band from a speaker of a first device, wherein the signal contains information to identify the first device to a second device containing a microphone;
(b) transmitting information for a transaction from the first device to a server on an out-of-band connection, wherein the transaction relates to the first device and the second device; and
(c) receiving at the first device authorization for the transaction from the server on the out-of-band connection, wherein the authorization is based at least in part on data from the second device.

20. The computer readable medium of claim 19, wherein the instructions, when executed, cause the signal to be transmitted within an ultrasonic band.
